(19) United States
(12) Patent Application Publication
(10) Pub. No.: US 2007/0187465 A1
(43) Pub. Date: Aug. 16, 2007

(54) Thermally enhanced tool for friction stirring

(76) Inventors: Ronald K. Eyre, Orem, UT (US); Russell J. Steel, Salem, UT (US)

Correspondence Address: MORRISS OBRYANT COMPAGNI, P.C., 734 EAST 200 SOUTH, SALT LAKE CITY, UT, 84102, US

(21) Appl. No.: 11/700,724

(22) Filed: Jan. 31, 2007

Related U.S. Application Data
(60) Provisional application No. 60/763,950, filed on Jan. 31, 2006.

(51) Int. Cl. A47J 36/02

(52) U.S. Cl. 228/101

(57) ABSTRACT

A friction stirring tool and a method for removing the catalytic phase from the friction stirring tool having a superabrasive coating by chemically etching, electrolytic etching or similar means to thereby at least partially remove a portion of the secondary catalytic phase metal from the superabrasive coating to thereby enhance the thermal stability of the tool and allow for longer life and the reduction or elimination of chemical reaction between the secondary metallic phase of the tool and a workpiece.

### CROSS REFERENCE TO RELATED APPLICATIONS

This document claims priority to, and incorporates by reference all of the subject matter included in the provisional patent application docket number 2293.SMII.PR2, having Ser. No. 60/763,950 and filed on Jan. 31, 2006.

### BACKGROUND OF THE INVENTION

1. Field Of the Invention

This invention relates generally to friction stir welding and friction stir processing wherein heat for welding or processing is generated by a rotating pin of a tool being pressed against or at least partially plunged into a workpiece. More specifically, the present invention relates to the removal of a secondary phase material from PCBN and PCD friction stirring tools to thereby enhance the thermal properties.

2. Description of Related Art

In U.S. Pat. No. 6,648,246 and U.S. Pat. No. 6,779,704, a new tool is taught that is capable of performing friction stir welding of metal matrix composites, ferrous alloys, non-ferrous alloys, and superalloys. This invention relates generally to an improved tool for solid state processing of high softening temperature materials (HSTM) through friction stirring (FS), including friction stir processing (FSP), friction stir mixing (FSM), friction stir welding (FSW), and friction stir spot welding (FSSW).

For the purposes of this document, HSTM should be considered to include materials such as metal matrix composites, ferrous alloys such as steel and stainless steel, and non-ferrous materials and superalloys. Superalloys can be materials having a higher melting temperature than bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium. Titanium should also be considered to be within the class of materials being considered. Titanium is a non-ferrous material, but has a higher melting point than other nonferrous materials.

Typically, a superabrasive material is disposed on the surface of a friction stir welding tool, enabling friction stirring of materials that were previously incapable of functional friction stirring with state of the art tools. The superabrasive materials typically disposed on the tool include polycrystalline cubic boron nitride (PCBN) and polycrystalline diamond (PCD). These superabrasive materials are going to be found on the periodic table and identified as compounds including elements extending from IIIA, IVA, VA, VIA, IIIB, IVB and VB.

Superabrasives have a hard primary or first phase, and a secondary catalytic or metallic phase that facilitates primary phase crystal structure sintering and transformation.

The superabrasive materials are disposed on the tool using a high temperature and high pressure (HTHP) process, as now understood by those skilled in the art. For example, cubic boron nitride (CBN) crystals can be mixed with a powder of a different or secondary phase material. The secondary phase material is either ceramic or metal based and may function, in part, as a catalytic material during the high temperature high pressure process. The CBN provides mechanical strength, while a ceramic will provide resistance to mechanical wear.

It is now known that the secondary phase material generally adds a toughness and chemical stability to the PCBN. The toughness is in part due to the ability of the secondary phase material to inhibit crack propagation. The CBN helps here as well, as it has randomly oriented fracture planes that naturally resist spalling. Lower CBN content is generally used for machining operations of hardened high temperature superalloys needing more chemical wear resistance and less mechanical wear resistance, wherein the secondary phase material is generally metallic for added toughness.

The CBN powder is disposed on a substrate such as cemented tungsten carbide, or even a free-standing PCBN blank, in a refractory metal container. The container is sealed and returned to a HTHP press, where the powder is sintered together and to the substrate to form a PCBN friction stirring tool blank. The PCBN friction stirring tool blank is then ground, lapped, wire EDM cut, or laser cut to shape and size, depending upon the application. After sintering in the HTHP press, the secondary catalytic phase material is now either a secondary phase metal or secondary phase ceramic.

The friction stirring process, including FSW, FSP and FSSP, are presently limited in the materials that can be worked upon. For example, friction stir welding tools using PCBN have difficulty working with titanium-based materials. Chemical reactions with titanium-based materials are a significant limitation due to the aluminum in the PCBN material. Aluminum in the PCBN material will react with titanium in the workpiece causing thermal damage through expansion of the metallic phase in the tool. Some secondary phase metals in the friction stir welding tool will thus lower the thermal stability of the tool and reduce tool life.

Likewise, friction stirring tools using PCD and PCD-like materials can also have problems because of a metallic phase. PCD friction stir welding tools are most often formed by sintering diamond powder with a suitable binder-catalyzing material in the HTHP press. PCD is often coupled to a tungsten carbide substrate. Such a substrate often includes cobalt. When subjected to high temperatures in the HTHP press, the cobalt migrates from the tool substrate into the diamond layer and acts as a binder-catalyzing material. Diamond particles bond to each other with diamond-to-diamond bonding, and also causing the diamond layer to bond to the tool substrate.

It is noted that although cobalt is most commonly used as the binder-catalyzing material, any group VIII element, including cobalt, nickel, iron, and alloys thereof might be used as the metallic phase material.

It would be an advantage over the state of the art to be able to provide a friction stirring tool having a superabrasive coating including a secondary metallic or ceramic phase material, wherein at least a portion of the secondary phase material is removed or reacted such that the superabrasive coating will not react with a workpiece.

As an example of the use of a friction stirring tool, FIG. 1 is used to illustrate in a perspective view a tool being used for friction stir welding that is characterized by a generally cylindrical tool 10 having a shoulder 12 and a pin 14 extending outward from the shoulder. The pin 14 and the shoulder 12 have disposed thereon a superabrasive coating.

The pin 14 is rotated against a workpiece 16 until sufficient heat is generated, at which point the pin of the tool is plunged into the plasticized workpiece material. The workpiece 16 is often two sheets or plates of material that are butted together at a joint line 18. The pin 14 is plunged into the workpiece 16 at the joint line 18. Although this tool has been disclosed in the prior art, it will be explained that the tool is modified by the present invention.

The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, re-crystallized, fine grain microstructure formed in the area of the weld.

### BRIEF SUMMARY OF THE INVENTION

In a preferred embodiment, the present invention is a friction stirring tool and a method for removing a secondary phase material from the friction stirring tool having a superabrasive coating by chemically etching, electrolytic etching or similar means to thereby at least partially remove a portion of the secondary phase material from the superabrasive coating to thereby enhance the thermal stability of the tool and allow for longer life and the reduction or elimination of chemical reaction between the secondary phase material of the tool and a workpiece.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a tool as taught in the prior art for friction stir welding, wherein the tool is improved by the present invention.

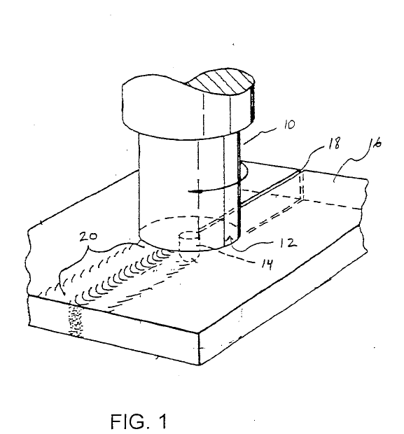

FIG. 2 is a cut-away profile view of a pin of a friction stirring tool, showing a superabrasive layer, and a region in which the secondary phase material has been removed therefrom.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It is known that the removal of secondary phase metallic material in PCD cutting tools has been highly effective in reducing thermal abrasive wear in rock cutting tools. Friction stirring processes have similar stability issues. Accordingly, it is an aspect of the present invention to improve friction stirring tools by removing material from a superabrasive coating that limits overall life and function of the tools.

It is known that exotic materials, especially those containing titanium, can be difficult to friction stir weld with PCBN due to the aluminum metallic phase in the PCBN reacting with the workpiece and causing an undesirable chemical reaction that will degrade the tool and shorten the tool life.

While PCD is more chemically inert, a friction stir welding tool with a PCD coating may also have thermal stability problems in some applications. PCD thermal stability problems are due to the secondary phase metallic material, typically cobalt, but can be any of the metals previously described.

The essence of the present invention is the removal or transformation of a thin layer of the secondary phase metallic or ceramic material within the superabrasive coating that is in contact with a workpiece. The result is a friction stirring tool that is thermally enhanced to thereby extend the life of the tool. By thermally enhancing the PCD, the inert properties of this material may be realized.

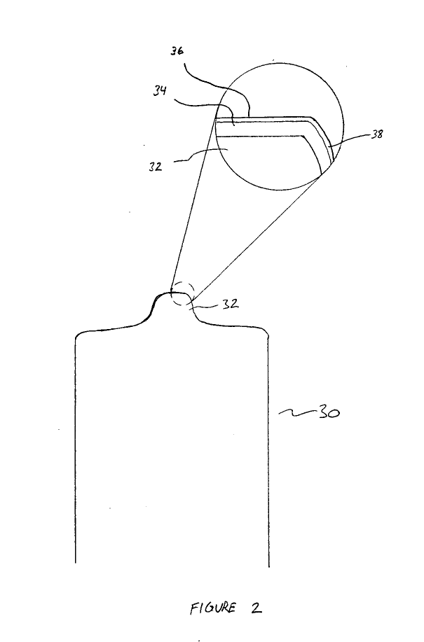

FIG. 2 is provided as a cut-away and close-up profile view of a friction stirring tool 30 that has been modified in accordance with the principles of the present invention. However, it should be remembered that there are other ways, as disclosed in this document, in which the friction stirring tool may be modified and still achieve the objectives of the present invention.

The friction stirring tool 30 includes a pin 32 that has a superabrasive coating 34 disposed thereon. The thickness shown for the superabrasive material should not be considered a realistic representation of the invention, but is instead exaggerating dimensions, and is being used for illustration purposes only. The superabrasive coating 34 includes a working surface 36 which makes contact with workpieces when friction stirring.

Most importantly, the superabrasive coating 34 includes a layer 38 beginning at the working surface 36 and extending down into the superabrasive coating where the secondary phase metallic or ceramic material has been removed or modified so as not to react with a workpiece, or interfere with thermal transfer characteristics.

Those skilled in the art of working with PCBN and PCD understand that there are various methods for moving or transforming a portion of the secondary phase metallic or ceramic material from a superabrasive coating.

For example, the secondary phase metallic or ceramic material can be leached using an acid etching process, an electrical discharge process, or other electrical or galvanic process, or by evaporation.

Another method of removing the secondary phase metallic or ceramic material is by combining it with another material so that the secondary phase metallic or ceramic material is no longer capable of performing the catalyst function. The material will thus remain in the superabrasive material, but simply not perform the catalyzing function.

Another method of eliminating the problem posed by the secondary phase metallic or ceramic material is to transform it into a material that no longer acts as a catalyzing material. Such a transformation may be a crystal structure change, mechanical working, chemical reaction, thermal treatment or other treatment methods.

It is another aspect of the present invention that only a portion of the secondary phase metallic or ceramic material needs to be removed or made ineffective as a catalyst. In other words, it is not necessary to completely remove or make inert all of the secondary phase metallic or ceramic material throughout the superabrasive coating 34.

It has been determined that effectiveness of the present invention in preventing a reaction of the PCBN or PCD friction stirring tool with a workpiece can be achieved with leached or transformed secondary phase metallic or ceramic material ranging from 0.010 mm to 0.50 mm in depth or greater from the working surface. For example, a working surface of a friction stirring tool formed of PCBN or PCD may be exposed to a solution of hydrofluoric and nitric acids or an aqua regia solution to remove a secondary phase metallic or ceramic material from the working surface.

It is noted that leaching or transforming the secondary phase metallic or ceramic material in the superabrasive layer to greater depths is a time consuming and often expensive process. Furthermore, experimentation has shown that leaching or transforming to greater depths is not any more effective in preventing a reaction between the friction stirring tool and a workpiece.

It is noted that the secondary phase metallic or ceramic material may be removed along a gradient. Thus, there may only be a gradual decrease in density of the secondary phase metallic or ceramic material while moving further into the superabrasive material 34, or the absence may be more abrupt. What is important is that there is an absence of the secondary phase metallic or ceramic material sufficient to enhance thermal stability or substantially reduce a reaction with a workpiece.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method of manufacturing a friction stirring tool capable of functionally friction stirring high softening temperature material (HSTM), said method comprising the steps of:
a) providing a superabrasive coating on a friction stirring tool using a high temperature and high pressure (HTHP) process, wherein the superabrasive coating includes a working surface, and wherein the superabrasive includes a hard primary phase and a secondary metallic or ceramic phase; and
b) processing the superabrasive coating such that the superabrasive coating is substantially free of material comprising the secondary phase metallic or ceramic material from the working surface to a desired depth.

2. The method as defined in claim 1 wherein the processing the superabrasive coating comprises leaching the material forming the secondary phase metallic or ceramic material from a working surface thereof.

3. The method as defined in claim 1 wherein the processing the superabrasive coating comprises converting the material forming the secondary phase metallic or ceramic material to a form such that the material does not adversely affect the workpiece.

4. The method as defined in claim 1 wherein the processing the superabrasive coating comprises reacting the material forming the secondary phase metallic or ceramic material so that the catalyzing material no longer has a catalyzing effect.

5. The method as defined in claim 1 wherein the processing the superabrasive coating comprises processing the superabrasive coating by electrical discharge to thereby remove the secondary phase metallic or ceramic material.

6. The method as defined in claim 1 wherein the processing the superabrasive coating comprises processing the superabrasive coating to a depth of at least 0.010 mm to thereby substantially prevent a catalytic reaction between a workpiece and the friction stirring tool.

7. The method as defined in claim 1 wherein the method further comprises the step of removing the material comprising the secondary phase metallic or ceramic material to a depth that substantially prevents a catalytic reaction between a workpiece and the friction stirring tool.

8. The method as defined in claim 1 wherein the method further comprises the step of thermally enhancing performance of the friction stirring tool through at least partial elimination of the secondary phase metallic or ceramic material from the superabrasive coating.

9. A friction stirring tool, comprising:
a friction stirring tool substrate;
a superabrasive coating disposed on the friction stirring tool substrate using a high temperature and high pressure (HTHP) process, wherein the superabrasive coating includes a working surface, and wherein the superabrasive includes a hard primary phase and a secondary metallic or ceramic phase; and
wherein at least a portion of the superabrasive coating is substantially free of material comprising the secondary phase metallic or ceramic material from the working surface to a desired depth.

10. The friction stirring tool as defined in claim 9 wherein the superabrasive coating is selected from the group of materials comprised of compounds including elements extending from IIIA, IVA, VA, VIA, IIIB, IVB and VB on the periodic table of the elements.

11. The friction stirring tool as defined in claim 10 wherein the superabrasive coating is selected from polycrystalline cubic boron nitride (PCBN) or polycrystalline diamond (PCD).

12. The friction stirring tool as defined in claim 9 wherein the material comprising the secondary phase metallic or ceramic material is removed to a depth that substantially prevents a catalytic reaction between a workpiece and the friction stirring tool.

13. A method of manufacturing a friction stir welding tool capable of functionally friction stir welding high softening temperature material (HSTM), said method comprising the steps of:
a) providing a superabrasive coating on a friction stir welding tool using a high temperature and high pressure (HTHP) process, wherein the superabrasive coating includes a working surface, and wherein the superabrasive includes a hard primary phase and a secondary metallic or ceramic phase; and
b) removing material comprising the secondary phase metallic or ceramic material from at least a portion of the working surface to a desired depth within the superabrasive coating.
